(19) United States
(12) Patent Application Publication
(10) Pub. No.: US 2020/0136099 A1
(43) Pub. Date: Apr. 30, 2020

(54) PACKAGED-INTEGRATED LITHIUM ION THIN FILM BATTERY AND METHODS FOR FABRICATING THE SAME

(71) Applicant: Intel Corporation, Santa Clara, CA (US)

(72) Inventors: Thomas L. SOUNART, Chandler, AZ (US); Sasha N. OSTER, Marion, IA (US); Veronica A. Strong, Chandler, AZ (US); Johanna M. SWAN, Scottsdale, AZ (US)

(21) Appl. No.: 16/606,698

(22) PCT Filed: Jun. 29, 2017
(86) PCT No.: PCT/US2017/040126

§ 371 Date: Oct. 18, 2019

(51) Int. Cl. H01M 2/02; H01M 10/0525; H01M 4/525; H01M 4/505; H01M 10/0585; H01M 2/20

(52) U.S. Cl. CPC H01M 2/0207; H01M 10/0525; H01M 4/525; H01M 2004/028; H01M 10/0585; H01M 2/204; H01M 2220/30; H01M 4/505

(57) ABSTRACT

Package-integrated thin film lithium ion battery and methods for fabricating the same are disclosed. In one example, an electronic package includes an organic package substrate, and a lithium (Li) ion thin film battery (TFB) integrated into the organic package substrate. The Li ion TFB is formed in or on the organic package substrate or the Li ion TFB can be embedded in the organic package substrate. The Li ion TFB includes an anode layer, electrolyte layer, cathode layer, and anode and cathode current collector layers. The cathode layer can be a crystalline transition metal oxide cathode layer including lithium cobalt oxide LiCoO2 (LCO) or lithium manganese oxide LiMn2O3 The cathode layer is laser annealed to crystallize the cathode layer. The organic package substrate is a low temperature substrate such that the organic package substrate is maintained at a temperature of 215 C or less when the cathode layer is laser annealed. The organic package substrate can also be a flexible organic package substrate.

### FIELD

The present invention relates generally to electronic packages and thin film batteries and, more particularly, to a packaged-integrated lithium ion thin film battery and methods for fabricating the same.

### BACKGROUND

Thin and flexible electronic systems are needed for the Internet-of-Things (IOT) devices, mobile devices, wearables, and autonomous vehicles. Thin film batteries (TFBs) can support such electronic systems by providing a flexible and thin power source. One type of TFB is a lithium (Li) ion TFB, which offers the highest operating voltage, high specific capacity, long cycle life, and uses a solid-state electrolyte providing safety, reliability, and stability at high temperatures without risk of electrolyte leakage and battery explosion. However, because high temperature is required to crystallize the cathode material of a Li ion TFB, existing Li ion TFBs are not fabricated on standard organic electronic package substrates. They are limited to fabrication on rigid and high temperature non-organic substrates such as silicon.

### BRIEF DESCRIPTION OF THE DRAWINGS

The appended drawings illustrate examples and are, therefore, exemplary embodiments and not considered to be limiting in scope.

FIG. 1 is an exemplary process fabricating an electronic package with an integrated Li ion TFB.

FIG. 2A is a cross-sectional view of one example of an electronic package with a Li ion TFB integrated into an organic package substrate.

FIG. 2B is a cross-sectional view of one example of an electronic package with a Li ion TFB integrated into an organic package substrate.

FIGS. 3A-3F are cross-sectional views of an electronic package illustrating how layers of a Li ion TFB are integrated into an organic package substrate.

FIG. 4 is a cross-sectional view of one example of an electronic package with a Li ion TFB embedded in an organic package substrate.

FIG. 5A is one example of a top view of an electronic package having an array of Li ion TFBs integrated into a flexible organic package substrate.

FIG. 5B is cross-sectional view of one example of the Li ion TFBs of FIG. 5A.

FIG. 6 is a cross-sectional view of one example of an electronic package with a multi-layer a Li ion TFB integrated into or embedded in an organic package substrate.

FIG. 7 is a schematic of an exemplary computing or data processing system which can use electronic packages with integrated Li ion TFBs.

### DETAILED DESCRIPTION

Package-integrated lithium ion thin film battery and methods for fabricating the same are described. In the following examples and embodiments, an electronic package includes an organic package substrate and a lithium (Li) ion thin film battery (TFB) integrated into the organic package substrate. The Li ion TFB can be formed in or on the organic package substrate or it can be embedded in the organic package substrate. The Li ion TFB can include a crystalline transition metal oxide cathode layer such as lithium cobalt oxide LiCoO₂ (LCO). In one example, the LCO layer is laser annealed to crystallize the LCO layer without significantly heating the substrate. The organic package substrate can be a low temperature substrate such that the organic package substrate is maintained at a temperature of 215° C. or less when the LCO layer is laser annealed to form the current collector layer for the lithium ion TFB. Thermal diffusion can dissipate the laser energy without significant heating to the organic package substrate. In other examples, the organic package substrate is a flexible organic package substrate.

As a result of the Li ion TFB integrated or formed on or in the organic package substrate as disclosed in the following examples and embodiments, an electronic package with an integrated lithium ion TFB provides a number of benefits such as, e.g., flexible form factors, negligible Z-height increase, high specific capacity, and no additional assembly to integrate the TFB into the electronic package. In the following examples and embodiments, a high-quality crystalline LCO thin film can be provided on or in organic substrates or integrated into the organic package substrate.

In the following examples and embodiments, an “electronic package” or “package” can be any type of electronic or integrated circuit (IC) package for any type of mobile device, computing device or data processing system. Examples of electronic packages can include through-hole packages, surface mount packages, chip carrier packages, pin grid array packages, flat packages, small outline packages, chip scale packages, ball grid array packages, and any other type of IC packages. Additionally, in the following examples and embodiments, an “package substrate,” “organic package substrate,” or “organic substrate” can include any type of organic material.

In the following description, numerous and specific details are set forth, such as packaging and thin film battery designs, in order to provide a thorough understanding of the examples and embodiments of the present invention. It will be apparent that the examples and embodiments described herein may be practiced without one or more of these specific details. In other instances, well-known features, such as packaging processes, have not described so as to avoid obscuring the details of the exemplary embodiments.

### Exemplary Process Fabricating an Electronic Package with an Integrated TFB

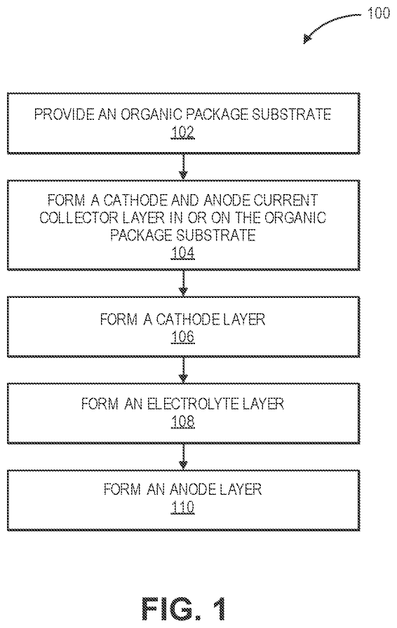

FIG. 1 is an exemplary process 100 fabricating an electronic package with an integrated Li ion TFB. The Li ion TFB is integrated into an organic substrate or package substrate of the electronic package. The Li ion TFB includes a cathode and anode current collector layer, cathode layer, electrolyte layer, and an anode layer. Process 100 includes steps 102 through 110 to fabricate the electronic package, however, steps 102 through 110 are not limited to any particular sequence or order.

At step 102, an organic package substrate is provided. The organic package substrate or package substrate can include any type of organic material. Package substrate can also include a filler or have multiple layers or include stacked substrates.

At step 104, a cathode and anode current collector layer is formed in or on the organic package substrate. In one example, the organic package substrate is patterned to form channels or trenches and deposited with a conductive material, e.g., copper (Cu), aluminum (Al), or platinum (P), to form a cathode or anode current collector layer connecting to a cathode or anode layer. The cathode current collector layer and anode current collector layer can also connect to other metal lines or traces by way of through-via connections. In other examples, the cathode and anode current collector layers can be formed on the organic package substrate such that the cathode current collector layer is also formed under a cathode layer and the anode current collector layer is also formed on an anode layer.

At step 106, the organic package substrate is patterned and a cathode layer is formed over the cathode current collector layer and on the organic package substrate. In one example, the cathode layer is formed by depositing a cathode material such as lithium cobalt oxide LiCoO₂ (LCO) or lithium manganese oxide LiMn₂O₃ or any other ceramic type material that can transport lithium Li ions. In one example, the cathode material or LCO layer is laser annealed to crystallize the cathode material or LCO layer and the organic package substrate can maintain a temperature of less than 215° C. during the laser annealing process. In one example, for laser annealing of the LCO layer, the laser annealing can provide laser pulses to the cathode or LCO layer. The laser pulse time can be shorter than the thermal diffusion time in the cathode or LCO layer or other layers. For this step, in one example, the laser energy or pulses are localized in the cathode or LCO layer during laser annealing. In other examples, multiple repeated laser pulses can provide enough time at crystallization temperature to form a crystalline cathode film in the cathode or LCO layer.

At step 108, the organic package substrate is patterned and an electrolyte layer is formed over the cathode layer. In one example, an electrolyte material such as a polymer or solid-state electrolyte film is deposited to form the electrolyte layer such as lithium phosphorous oxynitride LiPON or any other solid-state electrolyte that can transports Li ions.

At step 110, the organic package substrate is patterned and an anode layer is formed over the electrolyte layer. In one example, the anode is layer is formed by depositing an anode type material such as lithium, lithium oxide, or graphite. In one example, the anode layer is a negative electrode and the cathode layer is a positive electrode. In the above steps 102-110, the layers can also be embedded in the organic package substrate.

Cathode and anode current collector layers can deliver and receive power for the Li ion TFB 110 when discharging and recharging. For example, when charging, Li ions from the cathode layer (positive electrode) pass through the electrolyte layer to the anode layer (negative electrode) where they remain charging the battery. When discharging, Li ions move back from the anode layer through the electrolyte layer to the cathode layer.

### Exemplary Electronic Packages with Integrated TFBs

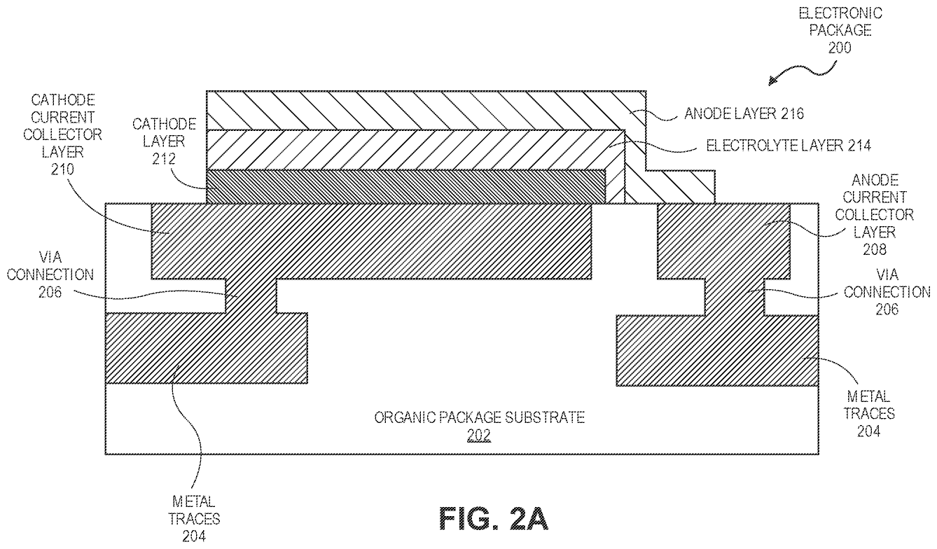

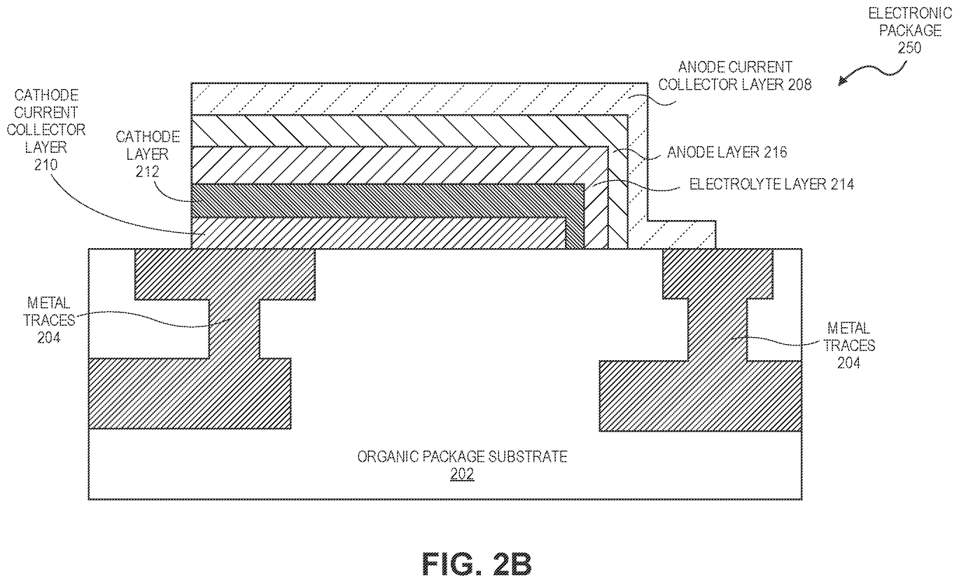

FIGS. 2A and 2B are cross-sectional views of examples of electronic packages 200 and 250 with a Li ion TFB integrated into an organic substrate 202 or package substrate. In the following examples and embodiments, fabrication processes (e.g., as disclosed in FIG. 1) can be used to form layers for the Li ion TFB, which are standard in high-volume panel processing such as, e.g., sputtering and laser annealing. In one example, a textured cathode layer can be formed using printed or sprayed particles and laser annealed so as to be formed on any type of organic material, substrate or package.

Referring to FIG. 2A, in one example, a Li ion TFB is formed on and in organic package substrate 202 including anode layer 216, electrolyte layer 214, cathode layer 212, cathode current collector layer 210, anode current collector layer 208. In other examples, the Li ion TFB includes via connections 206 and metal traces 204 coupled to cathode current collector layer 210 and anode current collector layer 208. Examples of cathode current collector layer 210 and anode current collector layer 208 can include metals such as copper (Cu), aluminum (Al), platinum (Pt) or any other type of conductive material, metal or alloy. Via connections 206 and metal traces 204 can also be the same material or layer or a combination of layers or materials forming cathode current collector layer 210 and anode current collector layer 208. For example, metal traces 204, via connections 206, cathode current collector layer 210 and anode current collector layer 108 can be the same conductive material and layer within the organic package substrate 202.

Cathode layer 212 is formed on current collector layer 210 and organic package substrate 202. Examples for cathode layer 112 can include a crystalline transition metal oxide cathode layer such as lithium cobalt oxide LiCoO₂ (LCO) or lithium manganese oxide LiMn₂O₃ or any other ceramic material that can transport Li ions. Electrolyte layer 214 is formed on cathode layer 212 and organic package substrate 202. Examples of electrolyte layer 214 can include a polymer or solid-state electrolyte film such as lithium phosphorus oxynitride LiPON or any other solid-state electrolyte that can transports Li ions. Electrolyte layer 214 can also prevent shorting between cathode layer 212 and anode layer 216. In other examples, a liquid or gel electrolyte with an appropriate separator can be used in lieu of a solid electrolyte layer 214. Anode layer 216 is formed on electrolyte layer 214. Examples of anode layer 216 can include an anode material such as lithium or graphite. In the example of FIG. 2A and the following examples, the layers that form the Li ion TFB stack can be formed in the reverse order such that the anode layer is under the electrolyte layer and the cathode layer is over the electrolyte layer. In such a configuration, the Li ions move in the opposite direction for charging and discharging the Li ion TFB.

In one example, for FIG. 2A, cathode layer 212, electrolyte layer 214, and anode layer 216 can be formed to be about 1 um in thickness as examples, but other thickness can be used for these layers. In one example, the lateral dimensions for cathode layer 212, electrolyte layer 214, and anode layer 216 can be any size within electronic package 200 footprint. In FIG. 2A, the patterned configuration for the layers are exemplary, and other shapes and structures can be formed to integrate the Li ion TFB into organic package substrate 202. Although not illustrated, in one example, electronic package 200 can be encapsulated or molded to protect and isolate it from the outside. In other examples, electronic package 200 can be a self-contained system and encapsulated on both top and bottom sides. Examples of the encapsulation material can include thermoplastic polyurethane (TPU).

In one example, for the Li ion TFB of FIG. 2A, the anode layer 216 is a negative electrode and the cathode layer 212 is a positive electrode. Cathode current collector layer 210 and anode current collector layer 208 can connect to metal traces 204 through via connections 206 to deliver power when discharging and receive power when recharging. In other examples, terminals for the Li ion TFB can have contacts on either the top or bottom of electronic package 200. In operation, for example, when the Li ion TFB is charging, Li ions from the cathode layer 212 (positive electrode) pass through electrolyte layer 214 to anode layer 216 (negative electrode) where they remain when charging the battery. When the Li ion TFB is discharging, Li ions move back from anode layer 216 through electrolyte layer 214 to cathode layer 212.

FIG. 2B is a cross-sectional view of one example of an electronic package 250 with a Li ion TFB integrated into organic package substrate 202. In this example, anode current collector layer 208 and cathode current collector layer 210 are formed on organic package substrate 202 in contrast to being formed in organic package substrate 202. Referring to FIG. 2B, cathode current collector layer 210 is formed on metal traces 204 and organic package substrate 202, and cathode layer 212 is formed on cathode collector layer 210 and organic package substrate 202. Electrolyte layer 214 is formed on cathode layer 212 and organic package substrate 202. Anode layer 216 is formed on electrolyte layer 214 and organic package substrate 202, and anode current collector layer 208 is formed on anode layer 216, organic package substrate 202 and metal traces 204. The layers and metals traces in FIG. 2B operate in the same way as in FIG. 2A for discharging and charging the Li ion TFB. In other examples, for FIG. 2B, the layers that form the Li ion TFB stack can be formed in the reverse order such that the anode layer and the anode current collector layer are formed under the electrolyte layer and the cathode layer and the cathode current collector layer are formed over the electrolyte layer.

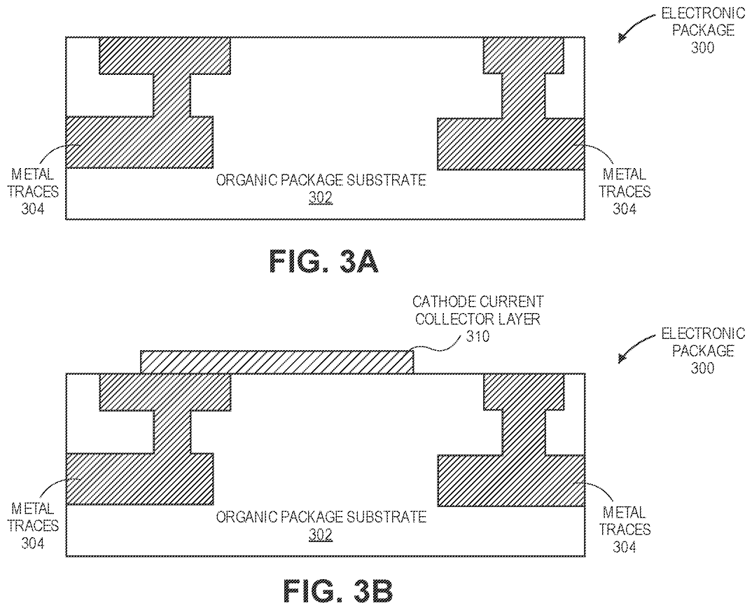

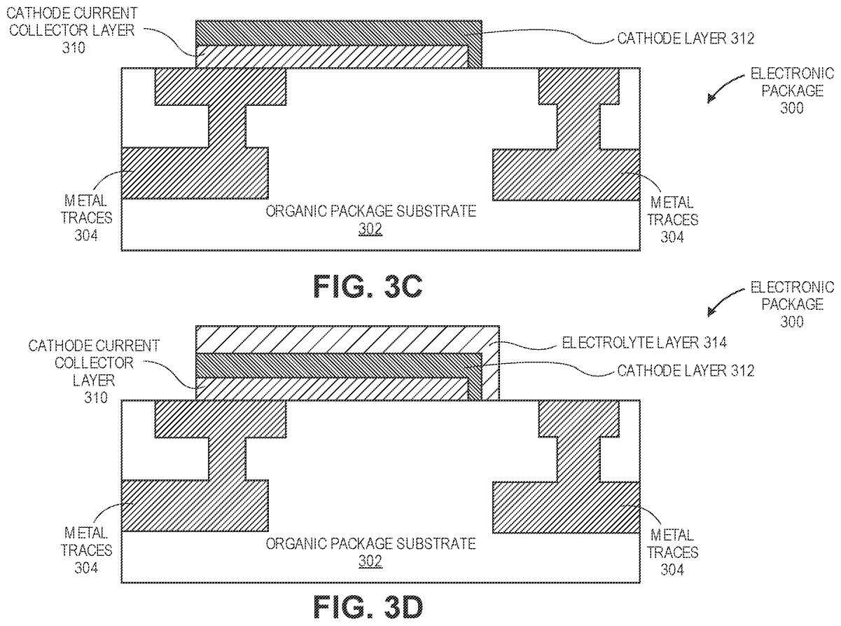

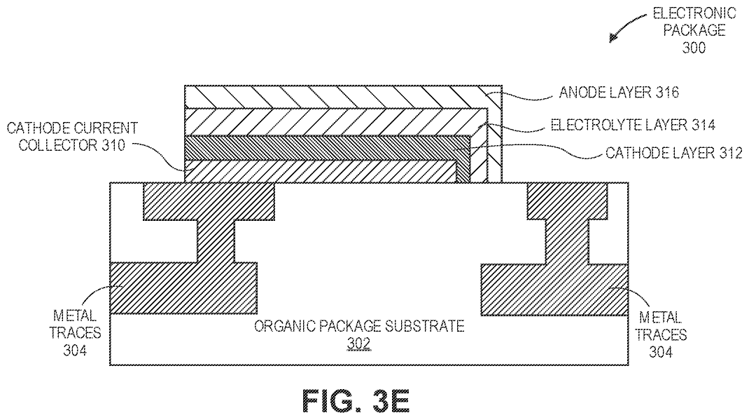

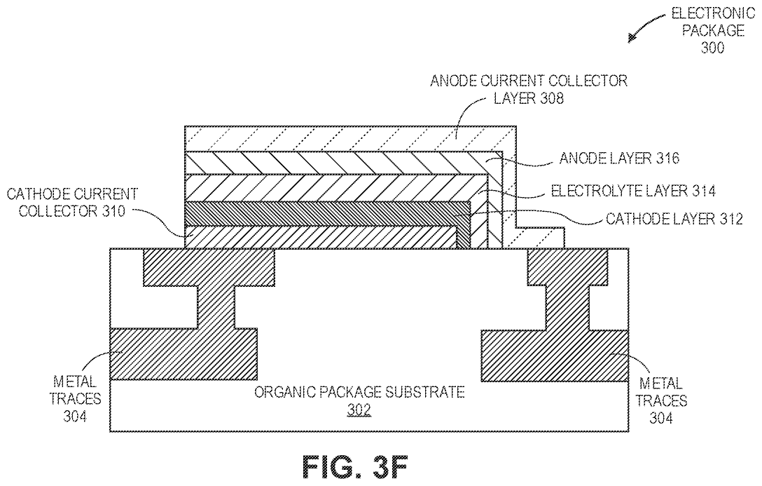

FIGS. 3A-3F are cross-sectional views of an electronic package 300 illustrating how layers are formed to integrate the Li ion TFB into organic package substrate 302. In this example, electronic package 300 is similar to electronic package 250 of FIG. 2B.

Referring to FIG. 3A, in one example, organic package substrate 302 with appropriate conductive material can be patterned with known lithographic methods to form metal traces 304. In one example, standard lithography and electroplating processes can be implemented in multiple levels to deposit conductive material for metal traces 304 such as copper (Cu), aluminum (Al), platinum (Pt). Referring to FIG. 3B, in one example, a metal or conductive layer is deposited and patterned on one side of metal traces 304 to form cathode current collector layer 310, which can be of the same or different conductive material as metal traces 304.

Referring to FIG. 3C, in one example, a cathode material is deposited and patterned to form cathode layer 312. Cathode layer 312 can be laser annealed to form a crystallized film for cathode layer 312 as disclosed in FIGS. 1 and 2A-2B. Referring to FIG. 3D, an electrolyte material is deposited and patterned to form electrolyte layer 314 on cathode layer 312 and organic package substrate 302. Referring to FIG. 3E, in on example, an anode type material is deposited and patterned to form anode layer 316 on electrolyte layer 314 and organic package substrate 302. Referring to FIG. 3F, in one example, a conductive material is deposited and patterned to form anode current collector layer 308 on anode layer 316, organic package substrate 302 and one side of metal traces 304. The Li ion TFB of FIG. 3F operates in the same manner as FIG. 2B. In other examples, the layers forming the Li ion TFB in FIGS. 3A-3F can be formed in the reverse order such that the anode layer and the anode current collector layer are formed under the electrolyte layer and the cathode layer and the cathode current collector layer are formed over the electrolyte layer.

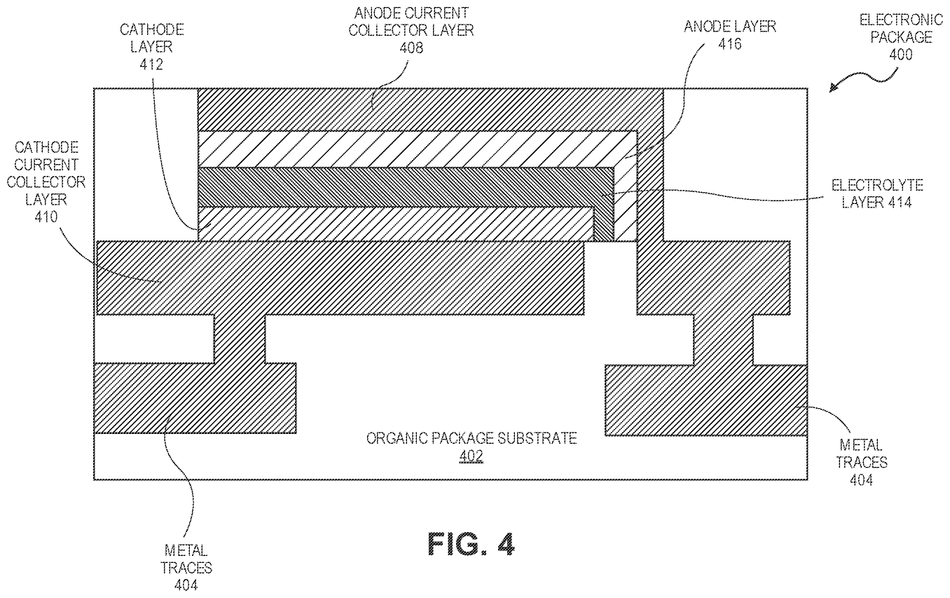

FIG. 4 is a cross-sectional view of one example of an electronic package 400 with a Li ion TFB integrated entirely within or embedded in organic package substrate 402. Referring to FIG. 4, metal traces 404 are formed in organic package substrate 402 and also form cathode current collector layer 410 and anode current collector layer 408. Cathode layer 412 is formed on cathode current layer 410 which is part of metal traces 404. Electrolyte layer 414 is formed on cathode layer 412 and anode layer 416 is formed on electrolyte layer 414. As shown, the anode and cathode current collector layers 408 and 410, cathode layer 412, electrolyte layer 414, and anode layer 416 are embedded in organic package substrate 402. Cathode current collector layer 410 can be formed using standard lithography and electroplating methods on an organic layer within organic package substrate 402. Cathode layer 412 can be deposited and patterned and the cathode layer 412 laser annealed to crystallize the layer accordingly. In one example, electrolyte layer 414, and anode layer 416 can be deposited and patterned, and the stack can be laminated with another organic layer within substrate 402. Anode current collector layer 408 can be deposited and patterned with lithography and electroplating methods, and laminated with another organic layer to complete organic package substrate 402 with the embedded Li ion TFB. In other examples, the order of the layers can be reversed, such that the bottom cathode current collector layer is the anode current collector layer, then the stack is formed by building up layers of the anode, the electrolyte, the cathode, and the cathode current collector layers.

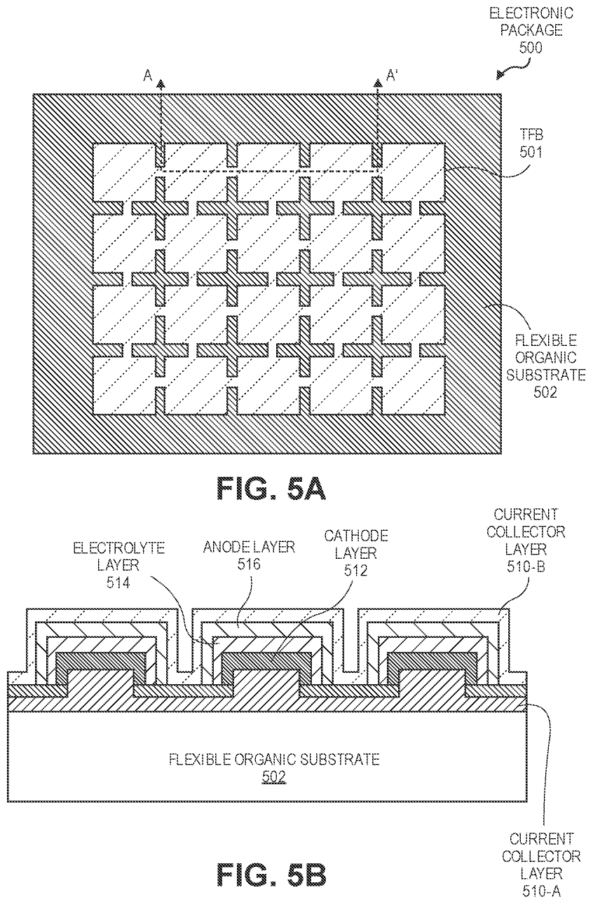

FIG. 5A is one example of a top view of an electronic package 500 having an array of Li ion TFBs 501 having layers laminated on a flexible substrate 502. Referring to FIG. 5A, the layers for TFB 501 can have a pattern a as shown. FIG. 5B is a cross-sectional view of one example of the array of Li ion TFBs of FIG. 5A taken along the line A-A′ of electronic package 500.

Referring to FIG. 5B, layers for the Li ion TFBs are formed on flexible substrate 502 to increase flexibility for the Li ion TFBs without cracking of the Li ion TFB layers and without having to delaminate the laminated layers. In one example, current collector layer 510-A is formed on flexible substrate 502 using known deposition processes, which can act as a cathode current collector layer. Cathode layer 512 is formed on the current collector layer 510-A, and an electrolyte layer 514 is formed on cathode layer 512. An anode layer 516 is formed on the electrolyte layer 514, and current collector layer 510-B is formed on the anode layer 516, which can act as an anode current collector layer. In one example, flexible substrate 502 and the Li ion TFB layers formed thereon can be part of a core of electronic package 500, which can be thicker in size than other package layers. In FIGS. 5A-5B, the layers can be formed and include the same materials as the Li ion TFB layers of FIGS. 1-4, but formed on flexible substrate 502, which can also be a flexible organic substrate or package substrates such as poly carbonates. Although not illustrated, the entire battery array can be encapsulated to further protect the TFBs from the outside environment. The layers for FIG. 5B can also be reversed such that anode and anode current collector layers can be formed under the electrolyte layer and the cathode and cathode current collector layers formed over the electrolyte layer.

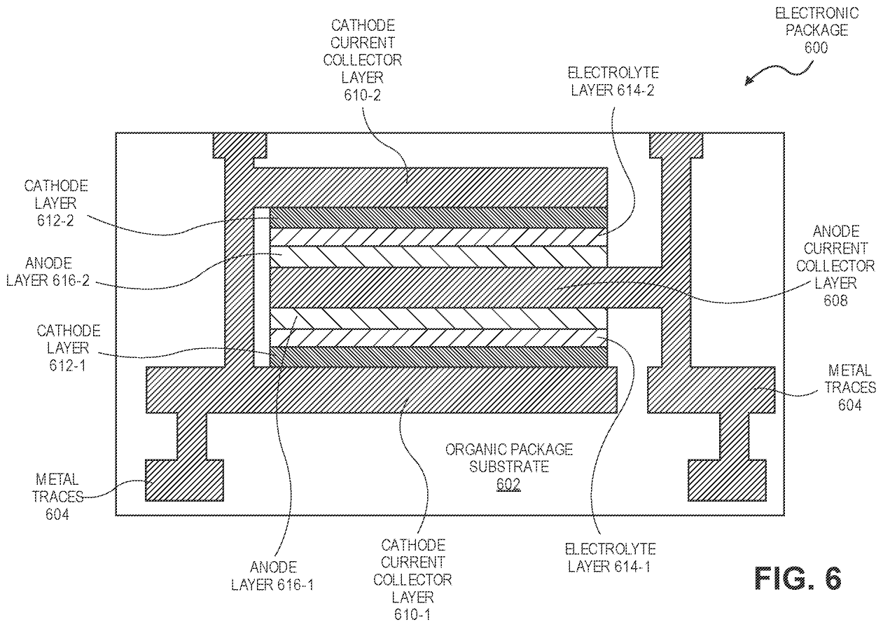

FIG. 6 is a cross-sectional view of one example of an electronic package 600 with a multi-layer Li ion TFB integrated into or embedded in organic package substrate 602 having metal traces 604. In this example, there are multiple battery layers within the package substrate 602, which are coupled in parallel to increase capacity. For example, one top Li ion TFB includes cathode current collector layer 610-2, cathode layer 612-2, electrolyte layer 614-2, anode layer 616-2, and anode current collector layer 608. One bottom Li ion TFB includes cathode current collector layer 610-1, cathode layer 612-1, electrolyte layer 614-1, anode layer 616-1, and anode current collector layer 608, which is shared by both the top and bottom Li ion TFBs. Metal traces 604 can be coupled to cathode current collector layers 610-1 and 610-2 and anode current collector layer 608. The battery layers can also be reversed to change the direction of Li ions for charging and discharging the TFB. In FIG. 6, electronic package 600 can include any number of Li ion TFBs and respective battery layers to increase battery capacity.

### Exemplary Computing or Data Processing System

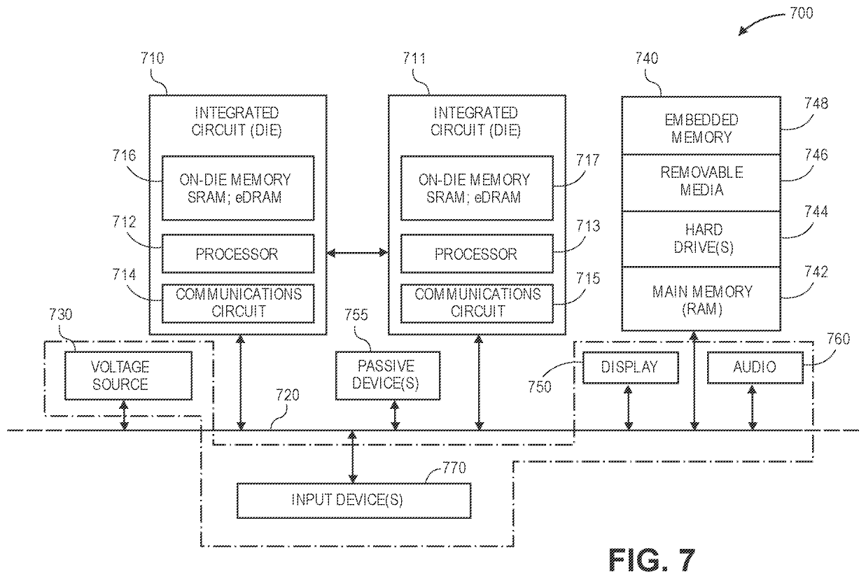

FIG. 7 is a schematic of an exemplary computing or data processing system 700 having electronic packages in which lithium ion TFBs can be integrated into the electronic packages. As shown, computing or data processing system 700 (also referred to as electronic system 700) can include and utilize integrated circuit (die) 710 and 711, which can be electronic packages along with other components, having integrated Li ion TFBs into a package substrate according to any of the examples described and disclosed in FIGS. 1A-6. Examples of electronic system 700 include mobile devices such as a netbook computer or a wireless smart phone, wearables such as watch or fitness tracker, a desktop computer, a hand-held reader, a server system, or a supercomputer or high-performance computing system or systems for autonomous automobiles.

In one example, electronic system 700 is a computer system that includes a system bus 720 to electrically couple the various components of electronic system 700. System bus 720 can be a single bus or any combination of busses according to various embodiments. Electronic system 700 includes a voltage source 730 that provides power to the integrated circuit 710. In some examples, voltage source 730 supplies current to integrated circuit 710 through system bus 720.

Integrated circuit 710 is electrically coupled to system bus 720 and includes any circuit, or combination of circuits on one or more silicon dies or tiles. In one example, integrated circuit 710 includes a processor 712 that can be of any type. As used herein, processor 712 may mean any type of circuit such as, but not limited to, a microprocessor, a microcontroller, a graphics processor, a digital signal processor, CPU or another processor. In one example, integrated circuit 710 includes an electronic package with a Li ion TFB integrated into the package substrate. In one example, SRAM embodiments are found in memory caches of the processor. Other types of circuits that can be included in integrated circuit 710 are a custom circuit or an application-specific integrated circuit (ASIC), such as communications circuit 714 for use in wireless devices such as cellular telephones, smart phones, pagers, portable computers, two-way radios, and similar electronic systems, or a communications circuit for servers. In one example, integrated circuit 710 includes on-die memory 716 such as static random-access memory (SRAM). In another example, integrated circuit 710 includes embedded on-die memory 716 such as embedded dynamic random-access memory (eDRAM). In one example, integrated circuit 710 is complemented with a subsequent integrated circuit 711. Useful examples include a dual processor 713 and a dual communications circuit 715 and dual on-die memory 717 such as SRAM. In one example, dual integrated circuit 710 includes embedded on-die memory 717 such as eDRAM.

In one example, electronic system 700 also includes an external memory 740 that in turn may include one or more memory elements suitable to the particular application, such as a main memory 742 in the form of RAM, one or more hard drives 744, and/or one or more drives that handle removable media 746, such as diskettes, compact disks (CDs), digital variable disks (DVDs), flash memory drives, and other removable media known in the art. The external memory 740 may also be embedded memory 948 such as the first die in a die stack, according to an embodiment.

In one example, electronic system 700 also includes a display device 750, an audio output 760. In one example, electronic system 700 includes an input device such as a controller 770 that may be a keyboard, mouse, trackball, game controller, microphone, voice-recognition device, or any other input device that inputs information into the electronic system 700. In an embodiment, an input device 670 is a camera. In an embodiment, an input device 770 is a digital sound recorder. In an embodiment, an input device 770 is a camera and a digital sound recorder.

As shown herein, integrated circuit 710 can be implemented in a number of different embodiments having lithium ion TFBs integrated into an electronic package substrate, e.g., as disclosed in FIGS. 1-6, for an electronic system or a computer system. The elements, materials, geometries, dimensions, and sequence of operations can all be varied to suit particular I/O coupling requirements including array contact count, array contact configuration for a microelectronic die embedded in a processor mounting substrate according to any of the several disclosed electronic package substrates with integrated lithium ion TFBs. A foundation substrate may be included, as represented by the dashed line of FIG. 7. Passive devices 755 may also be included, as is also depicted in FIG. 7.

Examples and embodiments of the present include package-integrated thin film lithium ion battery and methods for fabricating the same are described.

One example is an electronic package having an organic package substrate, and a lithium (Li) ion thin film battery (TFB) integrated into the organic package substrate.

In one example, wherein the Li ion TFB is formed in or on the organic package substrate.

In one example, the Li ion TFB is embedded in the organic package substrate.

In one example, the Li ion TFB includes an anode layer, electrolyte layer, cathode layer, and anode and cathode current collector layers.

In one example, the cathode layer is a crystalline transition metal oxide cathode layer including lithium cobalt oxide LiCoO2 (LCO) or lithium manganese oxide LiMn₂O₃.

In one example, the cathode layer is laser annealed to crystallize the cathode layer.

In one example, the organic package substrate is a low temperature substrate such that the organic package substrate is maintained at a temperature of 215° C. or less when the cathode layer is laser annealed.

In one example, the organic package substrate is a flexible organic package substrate.

One example is a method is for fabricating an electronic package including providing an organic package substrate, and integrating layers of a lithium (Li) ion thin film battery (TFB) into the organic package substrate.

In one example, cathode and anode current collector layers are formed in the organic package substrate. A cathode layer is formed on the cathode current collector layer. An electrolyte layer is formed on the cathode layer. An anode layer is formed on the electrolyte layer. The anode layer is connected to the anode current collector layer.

In one example, cathode and anode current collector layers are formed in the organic package substrate. An anode layer is formed on the anode current collector layer. An electrolyte layer is formed on the anode layer. A cathode layer is formed on the electrolyte layer. The cathode layer is connected to the cathode current collector layer.

In one example, a cathode current collector layer is formed on the organic package substrate. A cathode layer is formed on the cathode current collector layer. An electrolyte layer is formed on the cathode layer. An anode layer is formed on the electrolyte layer. An anode current collector layer is formed on the anode layer.

In one example, an anode current collector layer is formed on the organic package substrate. An anode layer is formed on the anode current collector layer. An electrolyte layer is formed on the anode layer. A cathode layer is formed on the electrolyte layer. A cathode current collector layer is formed on the cathode layer.

In one example, a cathode current collector layer, an anode current collector layer, a cathode layer, an anode layer, and electrolyte layer are embedded in the organic package substrate.

In one example, for any of the examples, metal traces are formed in the organic package substrate. The metal traces are coupled to the cathode and anode current collector layers.

In one example, a crystalline transition metal oxide cathode layer including lithium cobalt oxide LiCoO₂ (LCO) or lithium manganese oxide LiMn₂O₃ is deposited to form the cathode layer. The cathode layer is laser annealed to crystallize the cathode layer.

In one example, laser pulses are provided to the cathode layer to laser anneal the cathode layer.

In one example, the organic package substrate is maintained at a temperature of 215° C. or less when the cathode layer is laser annealed.

In one example, the organic package substrate is a flexible organic package substrate.

One example is a method for fabricating an electronic package including providing an organic package substrate, and depositing layers of a lithium (Li) ion thin film battery (TFB) on a flexible organic package substrate.

In one example, a cathode current collector layer is deposited on the flexible organic substrate. A cathode layer is deposited on the current collector layer. An electrolyte layer is deposited on the cathode layer. An anode layer is deposited on the electrolyte layer. An anode current collector layer is deposited on the anode layer.

In one example, an anode current collector layer is deposited on the flexible organic substrate. An anode layer is deposited on the current collector layer. An electrolyte layer is deposited on the anode layer. A cathode layer is deposited on the electrolyte layer. A cathode current collector layer is deposited on the cathode layer.

In one example, the cathode layer is laser annealed to crystallize the cathode layer.

In one example, metal traces are formed in the flexible organic package substrate. The metal traces are coupled to the cathode and anode current collector layers.

One example is an electronic system including a system bus, and a plurality of electronic packages coupled to the system bus. Each electronic package includes an organic package substrate, and a lithium (Li) ion thin film battery (TFB) integrated into the organic package substrate.

The foregoing description and drawings are to be regarded in an illustrative rather than a restrictive sense. Various modifications and changes may be made to the embodiments and examples described and disclosed herein without departing from the broader spirit and scope of the invention as set forth in the appended claims.

1. An electronic package comprising:
an organic package substrate; and
a lithium (Li) ion thin film battery (TFB) integrated into the organic package substrate.

2. The electronic package of claim 1, wherein the Li ion TFB is formed in or on the organic package substrate.

3. The electronic package of claim 1, wherein the Li on TFB is embedded in the organic package substrate.

4. The electronic package of claim 1, wherein the Li ion TFB includes an anode layer, electrolyte layer, cathode layer, and anode and cathode current collector layers.

5. The electronic package of claim 4, wherein the cathode layer is a crystalline transition metal oxide cathode layer including lithium cobalt oxide LiCoO2 (LCO) or lithium manganese oxide LiMn₂O₃

6. The electronic package of claim 5, wherein the cathode layer is laser annealed to crystallize the cathode layer.

7. The electronic package of claim 6, wherein the organic package substrate is a low temperature substrate such that the organic package substrate is maintained at a temperature of 215° C. or less when the cathode layer is laser annealed.

8. The electronic package of claim 1, wherein the organic package substrate is a flexible organic package substrate.

9. A method for fabricating an electronic package comprising:
providing an organic package substrate; and
integrating layers of a lithium (Li) ion thin film battery (TFB) into the organic package substrate.

10. The method of claim 9, wherein integrating the layers of Li ion TFB into the organic package substrate includes:
forming cathode and anode current collector layers in the organic package substrate;
forming a cathode layer on the cathode current collector layer;
forming an electrolyte layer on the cathode layer; and
forming an anode layer on the electrolyte layer, the anode layer is connected to the anode current collector layer.

11. The method of claim 9, wherein integrating the layers of Li ion TFB into the organic package substrate includes:
forming cathode and anode current collector layers in the organic package substrate;
forming anode layer on the anode current collector layer;
forming an electrolyte layer on the anode layer;
forming a cathode layer on the electrolyte layer, the cathode layer is connected to the cathode current collector layer.

12. The method of claim 9, wherein integrating the layers of Li ion TFB into the organic package substrate includes:
forming a cathode current collector layer on the organic package substrate;
forming a cathode layer on the cathode current collector layer;
forming an electrolyte layer on the cathode layer;
forming an anode layer on the electrolyte layer; and
forming an anode current collector layer on the anode layer.

13. The method of claim 9, wherein integrating the layers of Li ion TFB into the organic package substrate includes:
forming an anode current collector layer on the organic package substrate;
forming an anode layer on the anode current collector layer;
forming an electrolyte layer on the anode layer;
forming a cathode layer on the electrolyte layer; and
forming a cathode current collector layer on the cathode layer.

14. The method of claim 9, wherein integrating the layers of the Li ion TFB into the organic package substrate includes:
embedding a cathode current collector layer, an anode current collector layer, a cathode layer, an anode layer, and electrolyte layer in the organic package substrate.

15. The method of claim 10, wherein integrating the layers of Li ion TFB into the organic package substrate includes.
forming metal traces in the organic package substrate; and
coupling the metal traces to the cathode and anode current collector layers.

16. The method of claim 10, wherein integrating the layers of the Li ion TFB into the organic package substrate includes:
depositing a crystalline transition metal oxide cathode layer including lithium cobalt oxide LiCoO₂ (LCO) or lithium manganese oxide LiMn₂O₃ to form the cathode layer; and
laser annealing the cathode layer to crystallize the cathode layer.

17. The method of claim 16, wherein laser annealing the cathode layer includes providing laser pulses to the cathode layer.

18. The method of claim 16, wherein the organic package substrate is maintained at a temperature of 215° C. or less when the cathode layer is laser annealed.

19. The method of claim 18, wherein the organic package substrate is a flexible organic package substrate.

20. A method for fabricating an electronic package comprising:
providing an organic package substrate; and
depositing layers of a lithium (Li) ion thin film battery (TFB) on a flexible organic package substrate.

21. The method of claim 20, wherein depositing the layers of the Li ion TFB on the flexible organic package substrate includes:
depositing a cathode current collector layer on the flexible organic substrate;
depositing a cathode layer on the current collector layer;
depositing an electrolyte layer on the cathode layer;
depositing an anode layer on the electrolyte layer; and
depositing an anode current collector layer on the anode layer.

22. The method of claim 20, wherein depositing the layers of the Li ion TFB on the flexible organic package substrate includes:
depositing an anode current collector layer on the flexible organic substrate;
depositing an anode layer on the current collector layer;
depositing an electrolyte layer on the anode layer;
depositing a cathode layer on the electrolyte layer; and
depositing a cathode current collector layer on the cathode layer.

23. The method of claim 21, wherein depositing the cathode layer includes laser annealing the cathode layer to crystallize the cathode layer.

24. The method of claim 23, further comprising:
forming metal traces in the flexible organic package substrate; and
coupling the metal traces to the cathode and anode current collector layers.

25. An electronic system comprising:
a system bus; and
a plurality of electronic packages coupled to the system bus, each electronic package includes an organic package substrate, and a lithium (Li) ion thin film battery (TFB) integrated into the organic package substrate.
